(19) United States
(12) Patent Application Publication
(10) Pub. No.: US 2016/0092371 A1
(43) Pub. Date: Mar. 31, 2016

(54) Method and Apparatus For Deterministic Translation Lookaside Buffer (TLB) Miss Handling

(71) Applicant: INTEL CORPORATION, SANTA CLARA, CA (US)

(72) Inventor: VEDVYAS SHANBHOGUE, Austin, TX (US)

(21) Appl. No.: 14/498,321

(22) Filed: Sep. 26, 2014

(51) Int. Cl. G06F 12/10

(52) U.S. Cl. CPC G06F 12/1009; G06F 12/1027; G06F 2212/65; G06F 2212/684

(57) ABSTRACT

An apparatus and method are described for translation lookaside buffer (TLB) miss handling. For example, one embodiment of a processor comprises: a translation lookaside buffer (TLB) to store virtual-to-physical address translations; a page miss handler (PMH) to process TLB misses when a desired virtual-to-physical address translation is not present in the TLB; and a compressed page table to be managed by the PMH, the compressed page table to store specified portions of page tables, wherein in response to a TLB miss for a first address translation, the PMH is to check the compressed page table to determine if a page table entry corresponding to the first address translation is stored therein and, if so, to provide the first address translation from the compressed page table.

### BACKGROUND

1. Field of the Invention

This invention relates generally to the field of computer processors. More particularly, the invention relates to a method and apparatus for deterministic translation lookaside buffer (TLB) miss handling.

2. Description of the Related Art

Real time usages are required to meet a deadline deterministically. Usually such workloads require bounded interrupt latency. One source of non-determinism in interrupt handling are TLB misses which may be incurred for various memory accesses made during the interrupt delivery such as accesses to the Interrupt Descriptor Table (IDT), global descriptor table (GDT), local descriptor table (LDT), and stack. Missing in the TLB for any of these references requires a page table walk which may again take a non-deterministic amount of time depending on where in the cache and memory hierarchy the page table structure entries are located for the referenced linear address.

Existing processor architectures include a TLB lockdown mode where certain entries in the TLB can be marked as non-evictable. However marking TLB entries as non-evictable may be difficult to implemented on certain processor architectures (such as the Intel Architecture (IA)) because of interactions with events like system management interrupts (SMI) and instructions that are required to flush the entire TLB (e.g., INVEPT). Special logic to prevent eviction of these lockdown TLBs is expensive and difficult to validate.

Lockdowns are usually easier to build in fully associative TLBs which are very small (e.g., 32 or 48 entries), resulting in a greater performance impact when even a small number of entries are locked down. Building lockdowns into set associative TLBs would require way masks (e.g., where a subset of ways are marked as locked) or additional dedicated structures which would dramatically impact performance. In addition, a number of implementations require virtualization for security and reliability, which adds additional layers of complexity and result in conflicts between the non-evictable entries and other architectural policies (e.g., policies required to flush all entries associated with an address space ID (ASID) that is being reassigned). Moreover, existing architectures are not capable of preserving TLBs across deep sleep states such as C6. Consequently, building lockdown TLBs would require real time usages to disable sleep states, which is not desirable.

### BRIEF DESCRIPTION OF THE DRAWINGS

A better understanding of the present invention can be obtained from the following detailed description in conjunction with the following drawings, in which:

FIG. 1A is a block diagram illustrating both an exemplary in-order fetch, decode, retire pipeline and an exemplary register renaming, out-of-order issue/execution pipeline according to embodiments of the invention;

FIG. 1B is a block diagram illustrating both an exemplary embodiment of an in-order fetch, decode, retire core and an exemplary register renaming, out-of-order issue/execution architecture core to be included in a processor according to embodiments of the invention;

FIG. 2 is a block diagram of a single core processor and a multicore processor with integrated memory controller and graphics according to embodiments of the invention;

FIG. 3 illustrates a block diagram of a system in accordance with one embodiment of the present invention;

FIG. 4 illustrates a block diagram of a second system in accordance with an embodiment of the present invention;

FIG. 5 illustrates a block diagram of a third system in accordance with an embodiment of the present invention;

FIG. 6 illustrates a block diagram of a system on a chip (SoC) in accordance with an embodiment of the present invention;

FIG. 7 illustrates a block diagram contrasting the use of a software instruction converter to convert binary instructions in a source instruction set to binary instructions in a target instruction set according to embodiments of the invention;

FIG. 8 illustrates a system architecture on which embodiments of the invention may be implemented

FIG. 9 illustrates one embodiment of a page miss handler for implementing a compressed page table;

FIG. 10 illustrates an exemplary compressed page table employed in one embodiment of the invention; and

FIG. 11 illustrates a method in accordance with one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Processor Architectures and Data Types

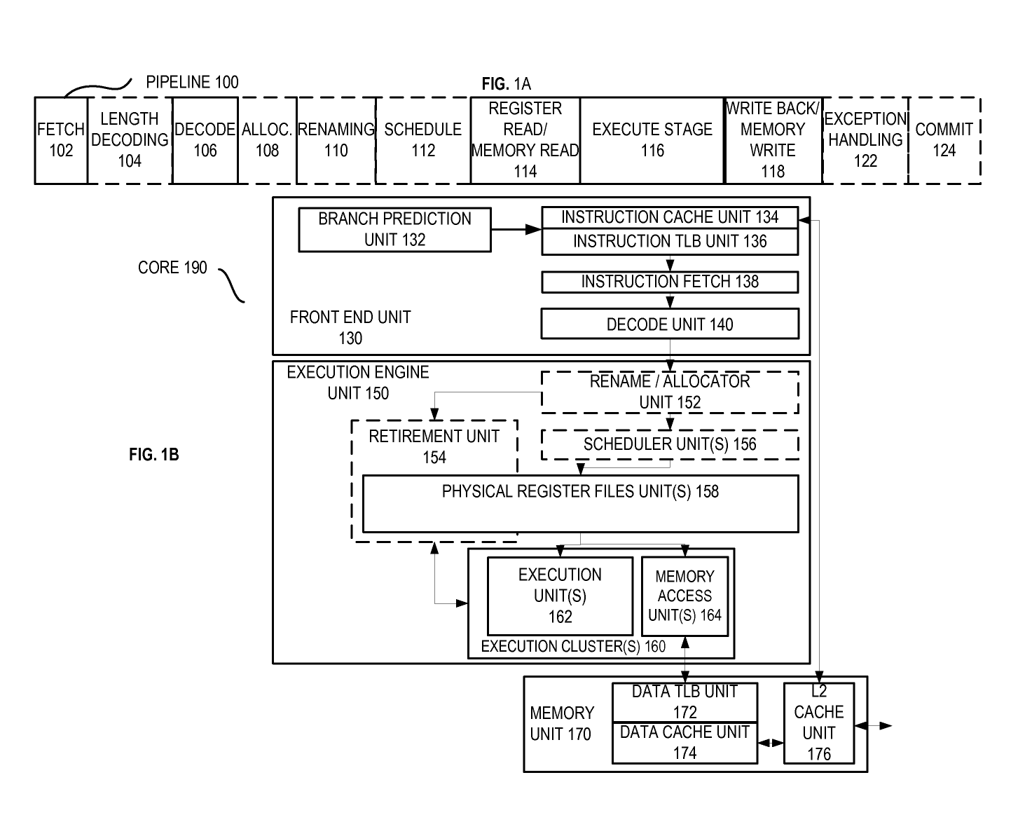

FIG. 1A is a block diagram illustrating both an exemplary in-order fetch, decode, retire pipeline and an exemplary register renaming, out-of-order issue/execution pipeline according to embodiments of the invention. FIG. 1B is a block diagram illustrating both an exemplary embodiment of an in-order fetch, decode, retire core and an exemplary register renaming, out-of-order issue/execution architecture core to be included in a processor according to embodiments of the invention. The solid lined boxes in FIGS. 1A-B illustrate the in-order portions of the pipeline and core, while the optional addition of the dashed lined boxes illustrates the register renaming, out-of-order issue/execution pipeline and core.

In FIG. 1A, a processor pipeline 100 includes a fetch stage 102, a length decode stage 104, a decode stage 106, an allocation stage 108, a renaming stage 110, a scheduling (also known as a dispatch or issue) stage 112, a register read/memory read stage 114, an execute stage 116, a write back/memory write stage 118, an exception handling stage 122, and a commit stage 124.

FIG. 1B shows processor core 190 including a front end unit 130 coupled to an execution engine unit 150, and both are coupled to a memory unit 170. The core 190 may be a reduced instruction set computing (RISC) core, a complex instruction set computing (CISC) core, a very long instruction word (VLIW) core, or a hybrid or alternative core type. As yet another option, the core 190 may be a special-purpose core, such as, for example, a network or communication core, compression engine, coprocessor core, general purpose computing graphics processing unit (GPGPU) core, graphics core, or the like.

The front end unit 130 includes a branch prediction unit 132 coupled to an instruction cache unit 134, which is coupled to an instruction translation lookaside buffer (TLB) 136, which is coupled to an instruction fetch unit 138, which is coupled to a decode unit 140. The decode unit 140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 190 includes a microcode ROM or other medium that stores microcode for certain macroinstructions (e.g., in decode unit 140 or otherwise within the front end unit 130). The decode unit 140 is coupled to a rename/allocator unit 152 in the execution engine unit 150.

The execution engine unit 150 includes the rename/allocator unit 152 coupled to a retirement unit 154 and a set of one or more scheduler unit(s) 156. The scheduler unit(s) 156 represents any number of different schedulers, including reservations stations, central instruction window, etc. The scheduler unit(s) 156 is coupled to the physical register file(s) unit(s) 158. Each of the physical register file(s) units 158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 158 comprises a vector registers unit, a write mask registers unit, and a scalar registers unit. These register units may provide architectural vector registers, vector mask registers, and general purpose registers. The physical register file(s) unit(s) 158 is overlapped by the retirement unit 154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 154 and the physical register file(s) unit(s) 158 are coupled to the execution cluster(s) 160. The execution cluster(s) 160 includes a set of one or more execution units 162 and a set of one or more memory access units 164. The execution units 162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 156, physical register file(s) unit(s) 158, and execution cluster(s) 160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 164). It should also be understood that where separate pipelines are used, one or more of these pipelines may be out-of-order issue/execution and the rest in-order.

The set of memory access units 164 is coupled to the memory unit 170, which includes a data TLB unit 172 coupled to a data cache unit 174 coupled to a level 2 (L2) cache unit 176. In one exemplary embodiment, the memory access units 164 may include a load unit, a store address unit, and a store data unit, each of which is coupled to the data TLB unit 172 in the memory unit 170. The instruction cache unit 134 is further coupled to a level 2 (L2) cache unit 176 in the memory unit 170. The L2 cache unit 176 is coupled to one or more other levels of cache and eventually to a main memory.

By way of example, the exemplary register renaming, out-of-order issue/execution core architecture may implement the pipeline 100 as follows: 1) the instruction fetch 138 performs the fetch and length decoding stages 102 and 104; 2) the decode unit 140 performs the decode stage 106; 3) the rename/allocator unit 152 performs the allocation stage 108 and renaming stage 110; 4) the scheduler unit(s) 156 performs the schedule stage 112; 5) the physical register file(s) unit(s) 158 and the memory unit 170 perform the register read/memory read stage 114; the execution cluster 160 perform the execute stage 116; 6) the memory unit 170 and the physical register file(s) unit(s) 158 perform the write back/memory write stage 118; 7) various units may be involved in the exception handling stage 122; and 8) the retirement unit 154 and the physical register file(s) unit(s) 158 perform the commit stage 124.

The core 190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 190 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 134/174 and a shared L2 cache unit 176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

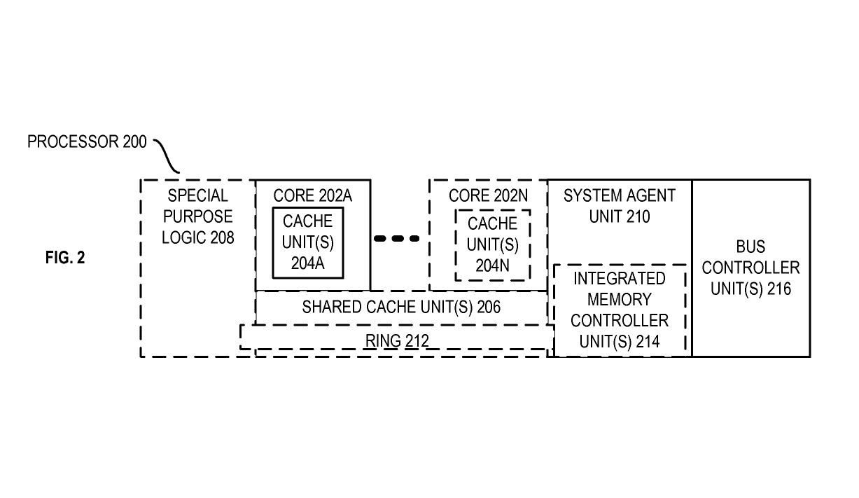

FIG. 2 is a block diagram of a processor 200 that may have more than one core, may have an integrated memory controller, and may have integrated graphics according to embodiments of the invention. The solid lined boxes in FIG. 2 illustrate a processor 200 with a single core 202A, a system agent 210, a set of one or more bus controller units 216, while the optional addition of the dashed lined boxes illustrates an alternative processor 200 with multiple cores 202A-N, a set of one or more integrated memory controller unit(s) 214 in the system agent unit 210, and special purpose logic 208.

Thus, different implementations of the processor 200 may include: 1) a CPU with the special purpose logic 208 being integrated graphics and/or scientific (throughput) logic (which may include one or more cores), and the cores 202A-N being one or more general purpose cores (e.g., general purpose in-order cores, general purpose out-of-order cores, a combination of the two); 2) a coprocessor with the cores 202A-N being a large number of special purpose cores intended primarily for graphics and/or scientific (throughput); and 3) a coprocessor with the cores 202A-N being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 206, and external memory (not shown) coupled to the set of integrated memory controller units 214. The set of shared cache units 206 may include one or more mid-level caches, such as level 2 (L2), level 3 (L3), level 4 (L4), or other levels of cache, a last level cache (LLC), and/or combinations thereof. While in one embodiment a ring based interconnect unit 212 interconnects the integrated graphics logic 208, the set of shared cache units 206, and the system agent unit 210/integrated memory controller unit(s) 214, alternative embodiments may use any number of well-known techniques for interconnecting such units. In one embodiment, coherency is maintained between one or more cache units 206 and cores 202-A-N.

In some embodiments, one or more of the cores 202A-N are capable of multi-threading. The system agent 210 includes those components coordinating and operating cores 202A-N. The system agent unit 210 may include for example a power control unit (PCU) and a display unit. The PCU may be or include logic and components needed for regulating the power state of the cores 202A-N and the integrated graphics logic 208. The display unit is for driving one or more externally connected displays.

The cores 202A-N may be homogenous or heterogeneous in terms of architecture instruction set; that is, two or more of the cores 202A-N may be capable of execution the same instruction set, while others may be capable of executing only a subset of that instruction set or a different instruction set. In one embodiment, the cores 202A-N are heterogeneous and include both the “small” cores and “big” cores described below.

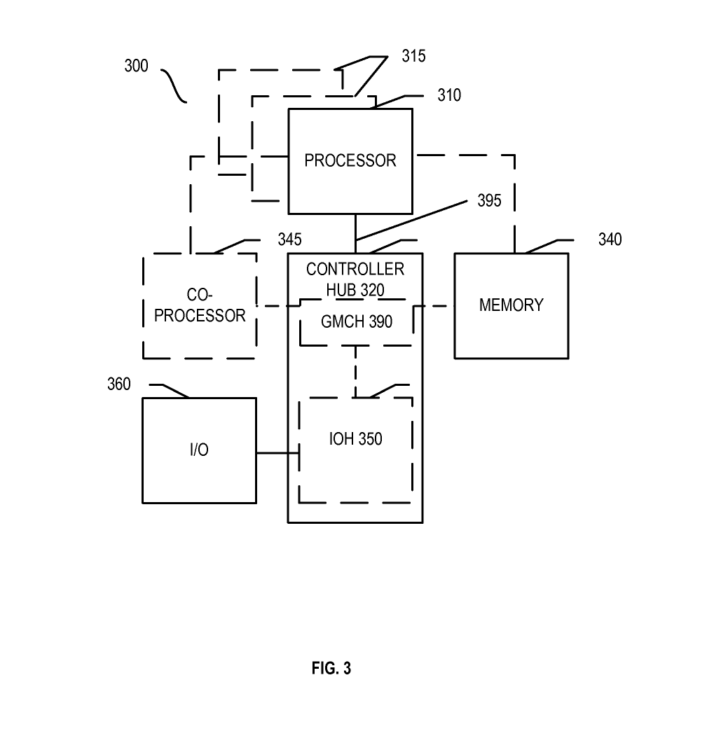

FIGS. 3-6 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 3, shown is a block diagram of a system 300 in accordance with one embodiment of the present invention. The system 300 may include one or more processors 310, 315, which are coupled to a controller hub 320. In one embodiment the controller hub 320 includes a graphics memory controller hub (GMCH) 390 and an Input/Output Hub (IOH) 350 (which may be on separate chips); the GMCH 390 includes memory and graphics controllers to which are coupled memory 340 and a coprocessor 345; the IOH 350 is couples input/output (I/O) devices 360 to the GMCH 390. Alternatively, one or both of the memory and graphics controllers are integrated within the processor (as described herein), the memory 340 and the coprocessor 345 are coupled directly to the processor 310, and the controller hub 320 in a single chip with the IOH 350.

The optional nature of additional processors 315 is denoted in FIG. 3 with broken lines. Each processor 310, 315 may include one or more of the processing cores described herein and may be some version of the processor 200.

The memory 340 may be, for example, dynamic random access memory (DRAM), phase change memory (PCM), or a combination of the two. For at least one embodiment, the controller hub 320 communicates with the processor(s) 310, 315 via a multi-drop bus, such as a frontside bus (FSB), point-to-point interface such as QuickPath Interconnect (QPI), or similar connection 395.

In one embodiment, the coprocessor 345 is a special-purpose processor, such as, for example, a high-throughput MIC processor, a network or communication processor, compression engine, graphics processor, GPGPU, embedded processor, or the like. In one embodiment, controller hub 320 may include an integrated graphics accelerator.

There can be a variety of differences between the physical resources 310, 315 in terms of a spectrum of metrics of merit including architectural, microarchitectural, thermal, power consumption characteristics, and the like.

In one embodiment, the processor 310 executes instructions that control data processing operations of a general type. Embedded within the instructions may be coprocessor instructions. The processor 310 recognizes these coprocessor instructions as being of a type that should be executed by the attached coprocessor 345. Accordingly, the processor 310 issues these coprocessor instructions (or control signals representing coprocessor instructions) on a coprocessor bus or other interconnect, to coprocessor 345. Coprocessor(s) 345 accept and execute the received coprocessor instructions.

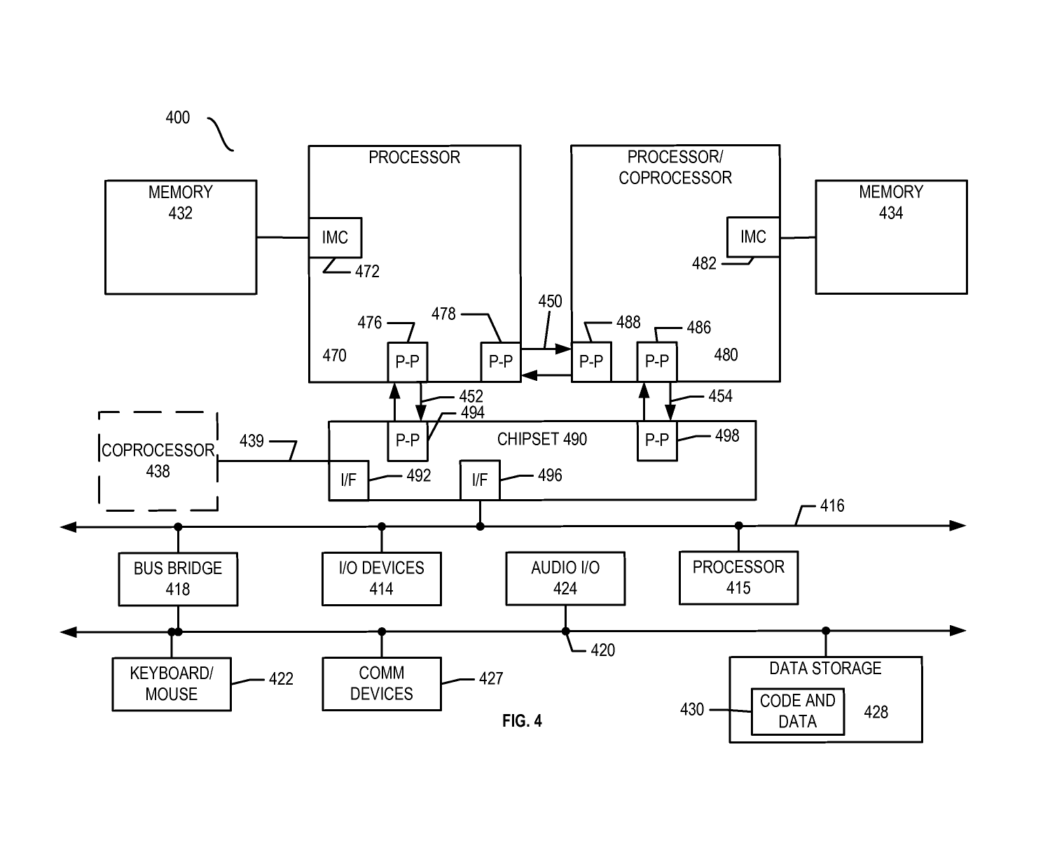

Referring now to FIG. 4, shown is a block diagram of a first more specific exemplary system 400 in accordance with an embodiment of the present invention. As shown in FIG. 4, multiprocessor system 400 is a point-to-point interconnect system, and includes a first processor 470 and a second processor 480 coupled via a point-to-point interconnect 450. Each of processors 470 and 480 may be some version of the processor 200. In one embodiment of the invention, processors 470 and 480 are respectively processors 310 and 315, while coprocessor 438 is coprocessor 345. In another embodiment, processors 470 and 480 are respectively processor 310 coprocessor 345.

Processors 470 and 480 are shown including integrated memory controller (IMC) units 472 and 482, respectively. Processor 470 also includes as part of its bus controller units point-to-point (P-P) interfaces 476 and 478; similarly, second processor 480 includes P-P interfaces 486 and 488. Processors 470, 480 may exchange information via a point-to-point (P-P) interface 450 using P-P interface circuits 478, 488. As shown in FIG. 4, IMCs 472 and 482 couple the processors to respective memories, namely a memory 432 and a memory 434, which may be portions of main memory locally attached to the respective processors.

Processors 470, 480 may each exchange information with a chipset 490 via individual P-P interfaces 452, 454 using point to point interface circuits 476, 494, 486, 498. Chipset 490 may optionally exchange information with the coprocessor 438 via a high-performance interface 439. In one embodiment, the coprocessor 438 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 490 may be coupled to a first bus 416 via an interface 496. In one embodiment, first bus 416 may be a Peripheral Component Interconnect (PCI) bus, or a bus such as a PCI Express bus or another third generation I/O interconnect bus, although the scope of the present invention is not so limited.

As shown in FIG. 4, various I/O devices 414 may be coupled to first bus 416, along with a bus bridge 418 which couples first bus 416 to a second bus 420. In one embodiment, one or more additional processor(s) 415, such as coprocessors, high-throughput MIC processors, GPGPU's, accelerators (such as, e.g., graphics accelerators or digital signal processing (DSP) units), field programmable gate arrays, or any other processor, are coupled to first bus 416. In one embodiment, second bus 420 may be a low pin count (LPC) bus. Various devices may be coupled to a second bus 420 including, for example, a keyboard and/or mouse 422, communication devices 427 and a storage unit 428 such as a disk drive or other mass storage device which may include instructions/code and data 430, in one embodiment. Further, an audio I/O 424 may be coupled to the second bus 420. Note that other architectures are possible. For example, instead of the point-to-point architecture of FIG. 4, a system may implement a multi-drop bus or other such architecture.

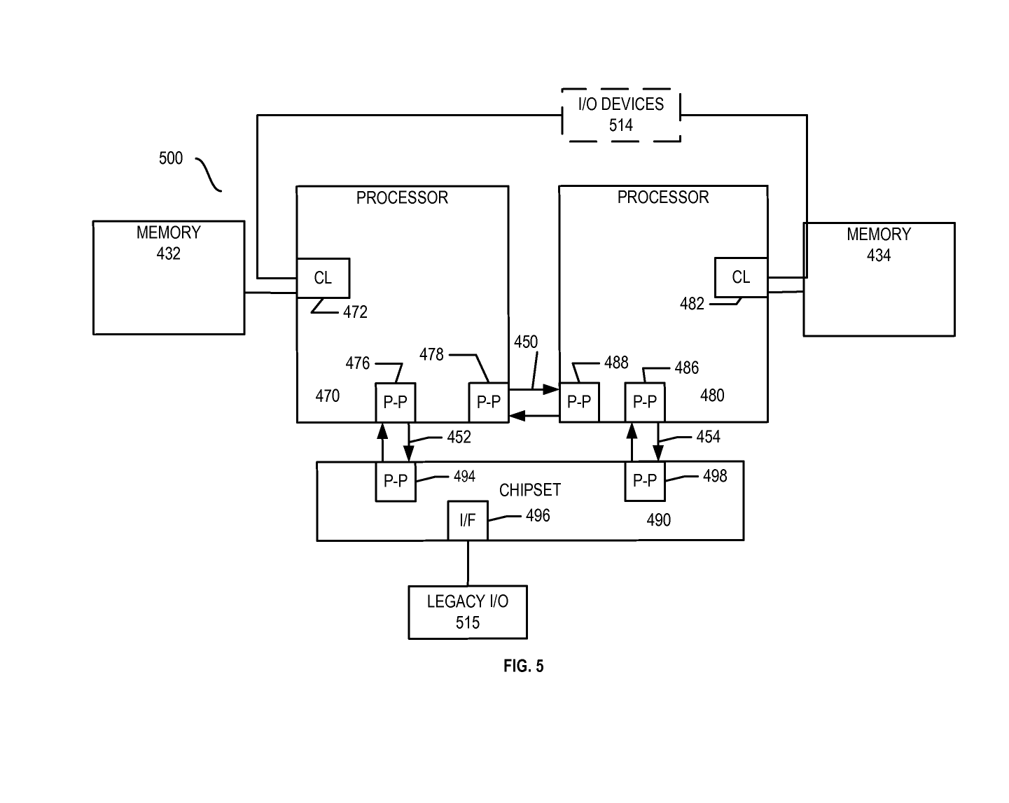

Referring now to FIG. 5, shown is a block diagram of a second more specific exemplary system 500 in accordance with an embodiment of the present invention. Like elements in FIGS. 4 and 5 bear like reference numerals, and certain aspects of FIG. 4 have been omitted from FIG. 5 in order to avoid obscuring other aspects of FIG. 5.

FIG. 5 illustrates that the processors 470, 480 may include integrated memory and I/O control logic (“CL”) 472 and 482, respectively. Thus, the CL 472, 482 include integrated memory controller units and include I/O control logic. FIG. 5 illustrates that not only are the memories 432, 434 coupled to the CL 472, 482, but also that I/O devices 514 are also coupled to the control logic 472, 482. Legacy I/O devices 515 are coupled to the chipset 490.

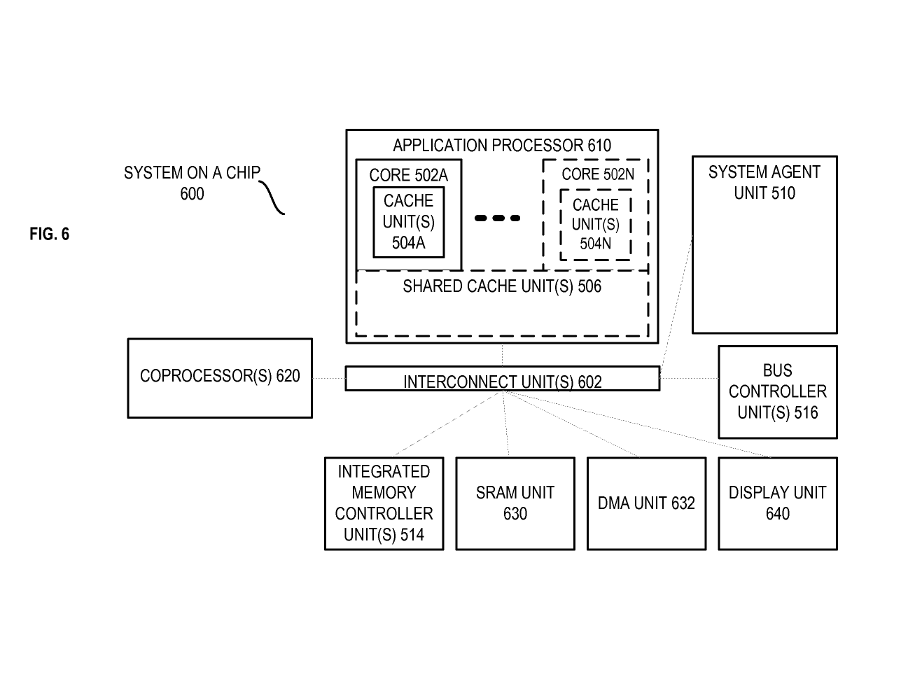

Referring now to FIG. 6, shown is a block diagram of a SoC 600 in accordance with an embodiment of the present invention. Similar elements in FIG. 2 bear like reference numerals. Also, dashed lined boxes are optional features on more advanced SoCs. In FIG. 6, an interconnect unit(s) 602 is coupled to: an application processor 610 which includes a set of one or more cores 202A-N and shared cache unit(s) 206; a system agent unit 210; a bus controller unit(s) 216; an integrated memory controller unit(s) 214; a set or one or more coprocessors 620 which may include integrated graphics logic, an image processor, an audio processor, and a video processor; an static random access memory (SRAM) unit 630; a direct memory access (DMA) unit 632; and a display unit 640 for coupling to one or more external displays. In one embodiment, the coprocessor(s) 620 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 430 illustrated in FIG. 4, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

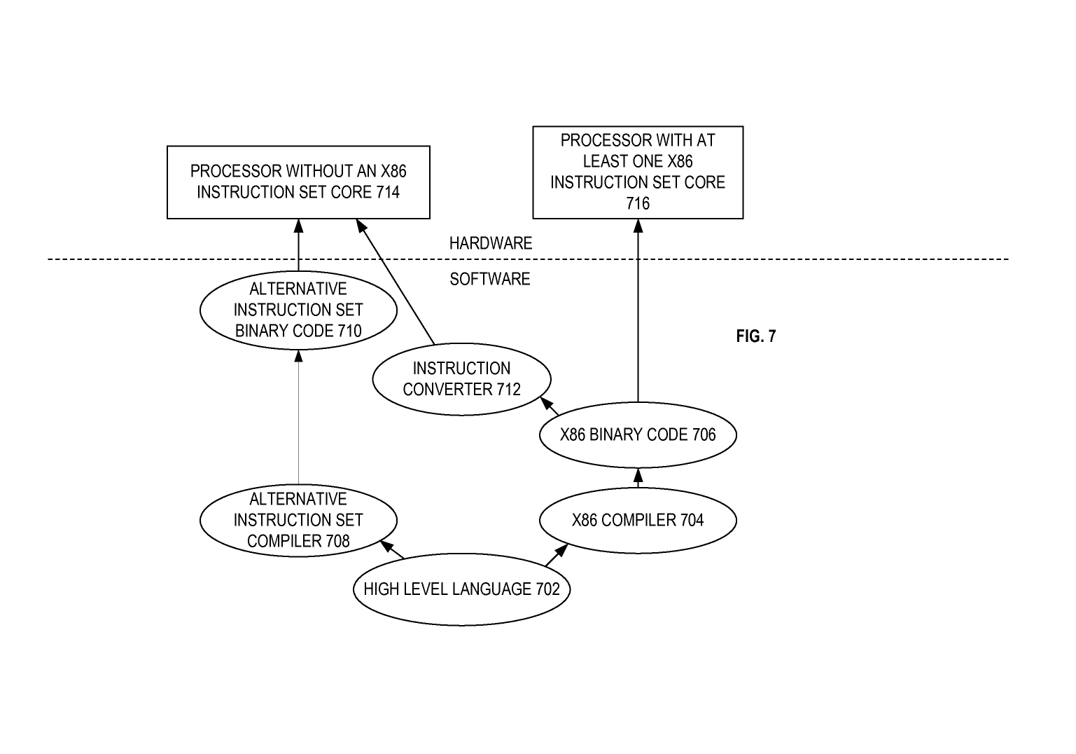

FIG. 7 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 7 shows a program in a high level language 702 may be compiled using an x86 compiler 704 to generate x86 binary code 706 that may be natively executed by a processor with at least one x86 instruction set core 716. The processor with at least one x86 instruction set core 716 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 704 represents a compiler that is operable to generate x86 binary code 706 (e.g., object code) that can, with or without additional linkage processing, be executed on the processor with at least one x86 instruction set core 716. Similarly, FIG. 7 shows the program in the high level language 702 may be compiled using an alternative instruction set compiler 708 to generate alternative instruction set binary code 710 that may be natively executed by a processor without at least one x86 instruction set core 714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 712 is used to convert the x86 binary code 706 into code that may be natively executed by the processor without an x86 instruction set core 714. This converted code is not likely to be the same as the alternative instruction set binary code 710 because an instruction converter capable of this is difficult to make; however, the converted code will accomplish the general operation and be made up of instructions from the alternative instruction set. Thus, the instruction converter 712 represents software, firmware, hardware, or a combination thereof that, through emulation, simulation or any other process, allows a processor or other electronic device that does not have an x86 instruction set processor or core to execute the x86 binary code 706.

### Method and Apparatus for Deterministic Translation Lookaside Buffer (TLB) Miss Handling

One embodiment of the invention includes techniques for enabling deterministic TLB miss responses. In particular, this embodiment provides a compressed representation of the page table for a small set of linear addresses in the page miss handler (PMH).

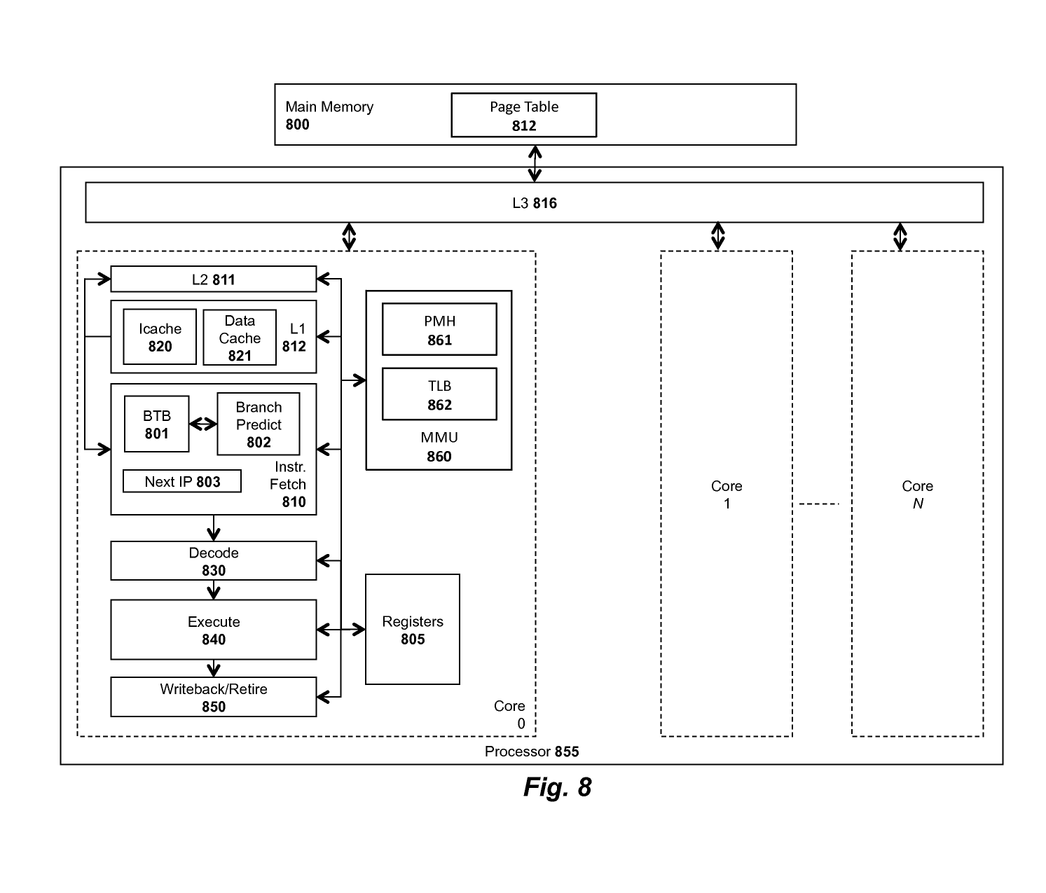

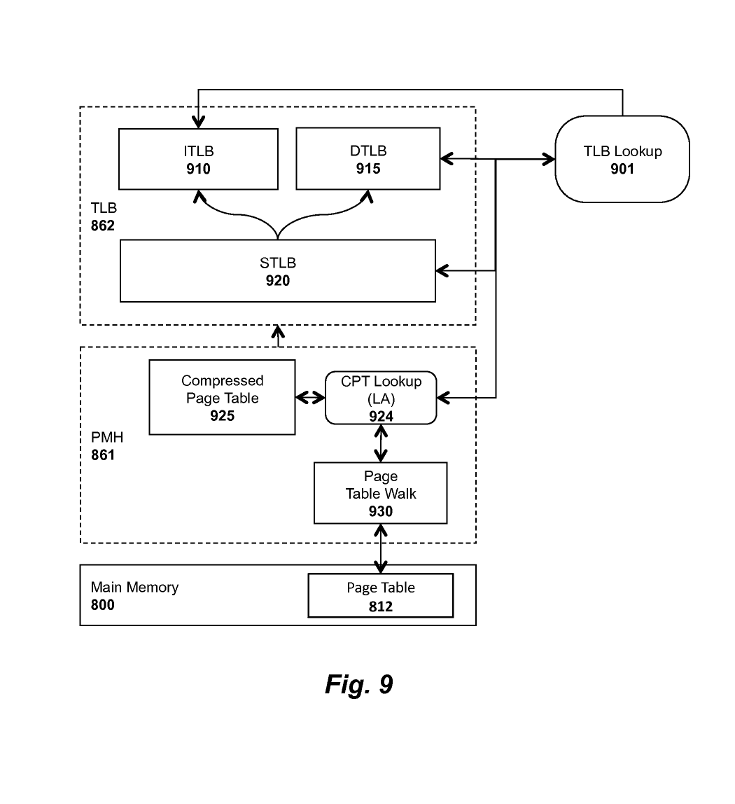

An exemplary processor 855 illustrated in FIG. 8 includes a memory management unit (MMU) 860 with a translation lookaside buffer (TLB) 862 and page miss handler 861 (described in greater detail below with respect to FIG. 9). The details of a single processor core (“Core 0”) are illustrated in FIG. 8 for simplicity. It will be understood, however, that each core shown in FIG. 8 (i.e., Core 1 . . . Core N) may have the same set of logic as Core 0. As illustrated, each core may also include a dedicated Level 1 (L1) cache 812 and Level 2 (L2) cache 811 for caching instructions and data according to a specified cache management policy. The L1 cache 811 includes a separate instruction cache 820 for storing instructions and a data cache 821 for storing data. The instructions and data stored within the various processor caches are managed at the granularity of cache lines which may be a fixed size (e.g., 64, 128, 512 Bytes in length). A register set 805 provides register storage for operands, control data and other types of data as the instruction stream is executed.

Each core of this exemplary embodiment has an instruction fetch unit 810 for fetching instructions from main memory 800 and/or a shared Level 3 (L3) cache 816; a decode unit 820 for decoding the instructions (e.g., decoding program instructions into micro-operatons or “uops”); an execution unit 840 for executing the instructions (e.g., the predicate instructions as described herein); and a writeback unit 850 for retiring the instructions and writing back the results. Each of these pipeline stages is well understood by those of skill in the art and will not be described here in detail to avoid obscuring the underlying principles of the invention.

The instruction fetch unit 810 includes various well known components including a next instruction pointer 803 for storing the address of the next instruction to be fetched from memory 800 (or one of the caches). In one embodiment, the instruction fetch unit 810 relies on an instruction translation look-aside buffer (ITLB) (see ITLB 910 in FIG. 9) for storing a map of recently used virtual-to-physical instruction addresses to improve the speed of address translation; a branch prediction unit 802 for speculatively predicting instruction branch addresses; and branch target buffers (BTBs) 801 for storing branch addresses and target addresses. Once fetched, instructions are then streamed to the remaining stages of the instruction pipeline including the decode unit 830, the execution unit 840, and the writeback unit 850.

FIG. 9 illustrates additional details associated with the TLB 862 and PMH 861 in accordance with one embodiment of the invention. The TLB 862 includes an instruction TLB 910 for storing recently used virtual-to-physical instruction addresses and a data TLB 915 for storing recently used virtual-to-physical addresses for data. In one embodiment, a shared TLB component 920 stores both instruction and data addresses and fills the ITLB 910 and DTLB 915. In one embodiment, on a ITLB 910 or a DTLB 915 miss responsive to the TLB lookup operation 901, the shared TLB 920 is consulted. If a translation requested by the TLB lookup 901 is found in the STLB 920 then the ITLB 910 or DTLB 915 may be filled from the STLB 920.

In one embodiment, on a STLB 920 miss, the page miss handler (PMH) 861 initially performs a lookup 924 in a compressed page table (CPT) 925 implemented in accordance with one embodiment of the invention (as described in greater detail below). The CPT lookup 924 includes the linear address (LA) for which a translation is needed. In one embodiment, if the LA is configured in the CPT 925, it then fills the TLB 862 with the translation from the CPT 925 (e.g., the STLB 920 and/or the ITLB/DTLB). If, however, the LA is not configured in the CPT 925, then page table walk logic 930 performs a page table walk operation to access the required portions of a page table 812 in system memory 800 (or via one of the various cache levels 811, 812, 816 which may store portions of the page table 812). Thus, in this embodiment of the invention, the page miss handler 861 provides a deterministic response time to STLB misses.

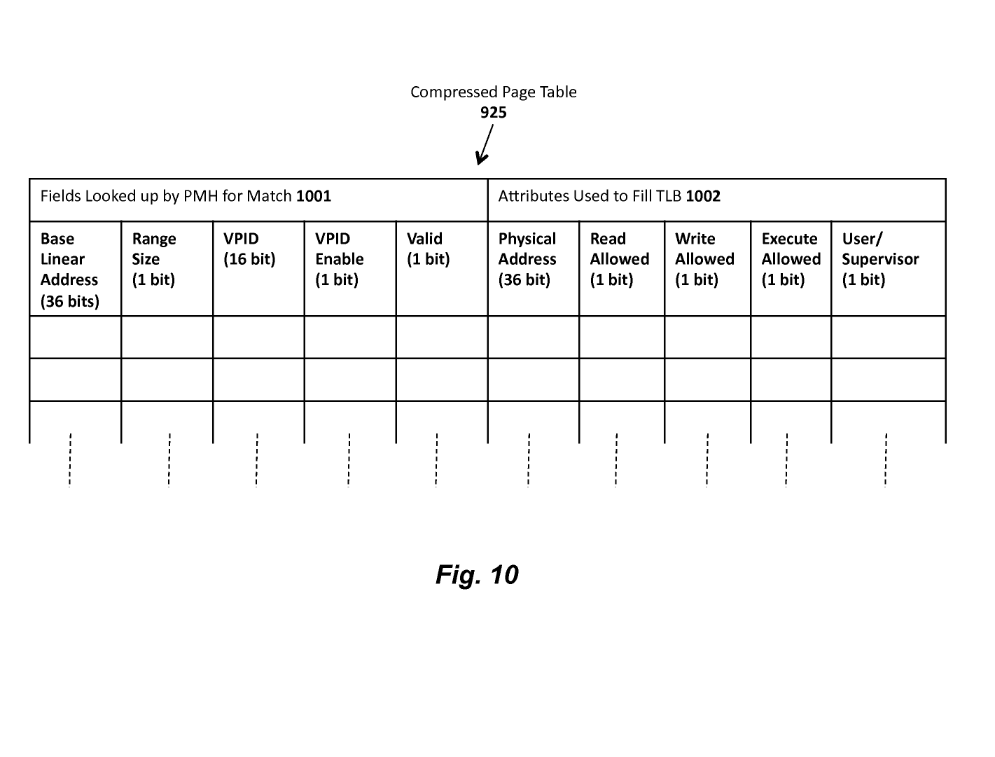

One embodiment of a compressed page table 925 managed by the PMH 861 is illustrated in FIG. 10. As illustrated, the exemplary compressed page table 925 includes a first set of fields 1001 looked up by the PMH 861 to determine a match and a second set of fields containing attributes used to fill the TLB 1002.

In one embodiment, the first set of fields 1001 include a base linear address which may be used as a tag to perform the lookup. The base linear address comprises a portion of the linear address such as the 36 most significant bits of the linear address. In addition, a range size may be specified to identify the page size associated with each entry. For example, different architectures may support page sizes of 4 KB, 2 MB, 4 MB and 1 GB. In one embodiment, the range specifies two different sizes, 4K or 2 MB, and is identified with 1 bit (i.e., 1=4 k and 0=2 MB). However, the underlying principles of the invention are not limited to this specific implementation.

In one embodiment, a virtual processor ID (VPID) is specified for virtualized implementations (e.g., in which a virtual machine supports multiple virtual processors). In one embodiment, the virtual processor ID is 16 bits in length and is specified by the virtual machine monitor (VMM). For example, software may be used to specify the VPID such that matching of entries in the table can be restricted to a subset based on the virtual processor ID (e.g., the compressed page table is only used for certain VPIDs). A VPID enable bit (e.g., 1 bit) may specify whether VPIDs are used. Thus, in the absence of a virtual environment (e.g., without VMM software), the VPID enable bit may be set to 0 to indicate that the VPID field need not be matched. When a VM entry is set by the VMM (e.g., using the VMLAUNCH/VMRESUME instructions), microcode indicates the current VPID of the virtual processor/machine to the PMH 861 (which updates the compressed page table 925 accordingly). When virtual machine extensions (VMX) are not enabled or on a virtual machine exit to the VMM microcode, the current VPID may be set to 0 (or some other predetermined value). in addition, a valid bit (e.g., 1 bit) is set to indicate whether the compressed page table entry is currently valid.

In one embodiment, the attributes used to fill the TLB 1002 include the physical address of the memory page (e.g., 36 bits), and a set of permissions associated with the physical memory page such as a read permission bit (indicating whether reads to the page are allowed), a write permission bit (indicating whether writes to the page are allowed), an execute permission bit (indicating whether execute protection is set for the page, preventing program code to be executed), and a user/supervisor bit (indicating whether the page is maintained in a user mode or a supervisor mode).

In one embodiment, all translations configured in the compressed page table 925 are considered global translations across all address space identifiers (ASI Ds) belonging to the configured VPID. The compressed page table illustrated in FIG. 10 has only one read, write and execute allowed bits. This implies that permission faults are reported to the highest privileged entity on the platform. For example, when in VMM guest mode, permission faults are reported as extended page table (EPT) violations and when in VMM root mode or when VMX is not enabled, they may be reported as page faults.

In one embodiment, when a STLB miss is detected, the missing linear address from the TLB lookup 901 is sent to the page miss handler (PMH) 861 as illustrated in FIG. 9 which performs the following operations:

1. The PMH 861 first matches the linear address in the compressed page table 925 along with the current VPID if the core is not in system management mode (SMM).

2. If no match is found the PMH 861 performs a page walk normally using the CR3 control register and/or extended page table pointer (EPTP) as applicable. The PMH 861 may then populate the STLB/ITLB/DTLB with the page table entries collected as a result of the page walk.

3. In one embodiment, if a match was detected then:
a. The PMH 861 verifies that the physical address (PA) configured in the compressed page table 925 does not match any reserved address ranges (e.g., as specified in system management range registers (SMRR) or processor reserved memory range registers (PRMRR)). If it does, it then aborts the operation (e.g., redirects the physical address to an abort page).
b. The PMH 861 also uses the PA to detect whether the access was to an advanced programmable interrupt controller (APIC) access page when the access was made by a VMM guest and whether the APIC access page has been configured.
c. The PMH 861 verifies the permissions to detect any faults (e.g. a write to a not-writeable page, an execute in a current privilege level (CPL) of 0 (CPL0) from a user page when supervisor mode execution prevention (SMEP) is enabled etc.).
d. If faults are detected then they are delivered normally.
e. If no faults are detected then the PMH 861 sends the PA from the table along with the permission attributes to the ITLB/STLB/DTLB depending on the type of access. In one embodiment, the translations are filled as global translations and the A and D bits of the page table entry are filled into the TLB at a value of 1.

The processor 855 may include an SRAM array to store the processor state to enable low power functionality such as the C6 power state functionality. In one embodiment, the compressed page table 925 (which, as mentioned, is configured by software in one embodiment) is preserved across low power states such as the C6 state in this SRAM. Thus, interrupts causing exit out of the deep sleep states will still be able to receive deterministic interrupt response times.

As mentioned above, the system management mode (SMM) may affect the operation of the PMH 861. For example, in one embodiment, when in SMM mode, the PMH will not detect any matches to the compressed page table 925 since the compressed page table belongs to non-SMM software.

In one embodiment, software manages the compressed page table structure using read model-specific register (RDMSR) and write model specific register (WRMSR) instructions. In this embodiment, the processor 855 provides the following 64 bit MSR configuration:
ENTRY_x_LA
Bits 63:48: VPID
Bits 47:12: Linear Address
Bit 11:9: Reserved
Bit 8: VPID ENABLE
Bit 7: Page size (0-4K, 1-2M)
Bit 6:3: Reserved
Bit 2: U/S
Bit 1: Reserved
Bit 0: Valid
ENTRY_x_PA_ATTR
Bits 63: Max_Phys_Addr: Reserved
Bits Max_Phys_Addr:12: PA
Bits 11:3: Reserved
Bit 2: Executable
Bit 1: Writeable
Bit 0: Readable

In one embodiment, in 32-bit and 16-bit modes only LA 31:12 will be matched. In 64-bit mode, the LA will be made canonical and matched against the LA missing the TLB.

In one embodiment, software manages the compressed page table 925 in a similar manner as it would manage a memory-resident page table. Since the contents of the compressed page table 925 may be cached in the TLBs, software may invalidate the TLB entries using the Invalidate TLB Entry instruction (INVLPG) and the INVVPID instruction which invalidates cached mappings of address translations based on the virtual processor ID. Entries are invalidated as appropriate to ensure that modifications in the compressed page table 925 are reflected on subsequent accesses.

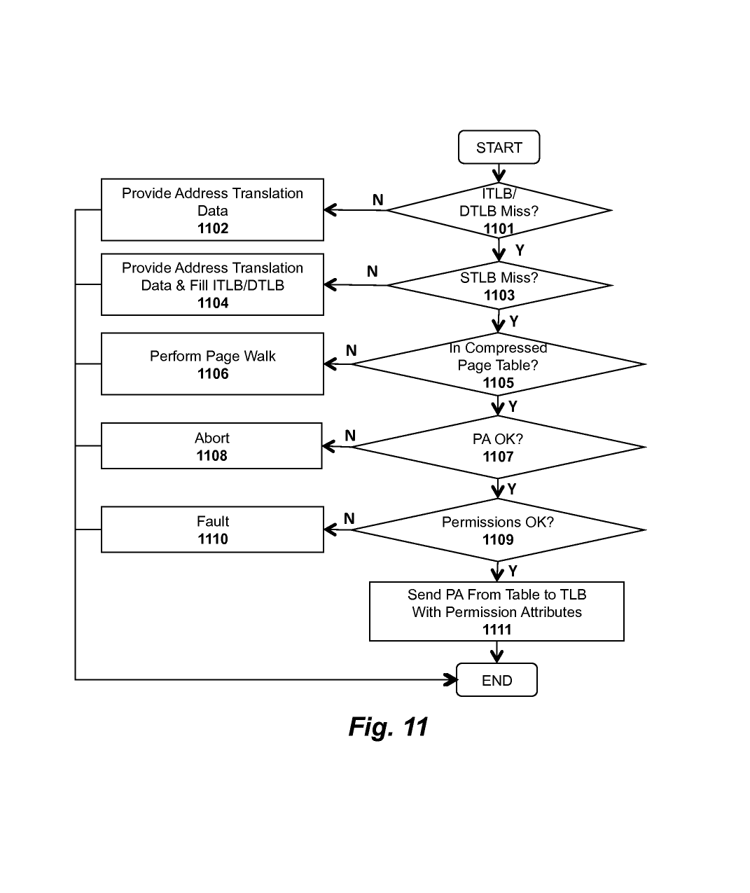

A method in accordance with one embodiment of the invention is illustrated in FIG. 11. The method may be implemented within the context of the processor architecture described above, but is not limited to any particular architecture.

A check is initially performed to determine whether the ITLB or DTLB have the needed address translations. In response to an ITLB/DTLB hit, determined at 1101, the address translation data is provided at 1102. In response to an ITLB/DTLB miss at 1101, the STLB is checked at 1103. If the data is in the STLB, then at 1104, the address translation data is provided and the ITLB/DTLB is filled with the translation data from the STLB at 1104.

In response to an STLB miss at 1103, the compressed page table is consulted at 1105 (e.g., by the PMH in one embodiment). If the data is not in the compressed page table, then at 1106, a page walk is performed to retrieve the translation(s) from the page tables stored in memory (or in one of the cache levels).

If the translation data is stored in the compressed page tables, then at 1105 checks are performed to determined whether the physical address(es) read from the compressed page tables are acceptable. For example, as mentioned above, the PMH may verify that the physical address (PA) configured in the compressed page table does not match any reserved address ranges (e.g., as specified SMRR or PRMRR registers). If it does, it then the operation is aborted at 1108. In addition, the PMH may also use the PA to detect whether the access was to an advanced programmable interrupt controller (APIC) access page when the access was made by a VMM guest and whether the APIC access page has been configured.

If the PA determined to be acceptable at 1107, then the permissions associated with the PA are evaluated at 1109 within the context of the desired operation. For example, as mentioned above, the PMH may verify the permissions to detect any faults such as a write to a not-writeable page or an execute in a current privilege level (CPL) of 0 (CPL0) from a user page when supervisor mode execution prevention (SMEP) is enabled, etc. If permissions indicate that the desired operation is not permitted, then a fault is generated at 1110. If permissions indicate that the operation is acceptable, then at 1111, the PA is provided and is sent from the compressed page table to the TLB (i.e., the STLB and/or the ITLB/DTLB) along with the permission attributes.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor comprising:
a translation lookaside buffer (TLB) to store virtual-to-physical address translations;
a page miss handler (PMH) to process TLB misses when a desired virtual-to-physical address translation is not present in the TLB; and
a compressed page table to be managed by the PMH, the compressed page table to store specified portions of page tables, wherein in response to a TLB miss for a first address translation, the PMH is to check the compressed page table to determine if a page table entry corresponding to the first address translation is stored therein and, if so, to provide the first address translation from the compressed page table.

2. The processor as in claim 1 wherein the PMH includes page walk logic to perform a page walk operation to read entries from page tables stored in a system memory if the first address translation is not found in the compressed page table.

3. The processor as in claim 2 wherein the PMH is to update a shared TLB (STLB), data TLB (DTLB) and/or instruction TLB (ITLB) to include an address translation read from page tables stored in system memory in response to the page walk operation.

4. The processor as in claim 1 wherein the TLB comprises:
an instruction TLB (ITLB) to store address translations associated with instructions;
a data TLB (DTLB) to store address translations associated with data; and
a shared TLB (STLB) to store address translations for both instructions and data;
wherein the PMH fills the STLB and/or the ITLB/DTLB using an address translation from the compressed page table when a desired virtual-to-physical address translation is not present in the STLB or ITLB/DTLB.

5. The processor as in claim 1 wherein entries in the compressed page table comprise:
a first set of fields to be used by the PMH to determine a match using a linear address (LA); and
a second set of fields including a physical address (PA) corresponding to the LA.

6. The processor as in claim 5 wherein the first set of fields includes a virtual processor ID (VPID) field to indicate a virtual processor to which each compressed page table entry is assigned.

7. The processor as in claim 6 wherein the first set of fields further includes a range size field to indicate a page size used in the page tables.

8. The processor as in claim 5 wherein the second set of fields further includes a set of permission bits indicating permissions associated with the page tables.

9. The processor as in claim 8 wherein the permissions include write enable, read enable, and execute enable.

10. The processor as in claim 5 wherein the second set of fields further includes a user/supervisor bit to indicate a user or supervisor mode of operation.

11. A method comprising:
storing virtual-to-physical address translations in a translation lookaside buffer (TLB);
storing portions of page tables within a compressed page table;
in response to a TLB miss for a first virtual-to-physical address translation, determining whether the first virtual-to-physical address translation is stored within the TLB;
checking the compressed page table for the first virtual-to-physical address translation in response to a TLB miss to determine if a page table entry corresponding to the first virtual-to-physical address translation is stored within the compressed page table and, if so, providing the first virtual-to-physical address translation from the compressed page table.

12. The method as in claim 11 further comprising:
performing a page walk operation to read entries from page tables stored in a system memory if the first virtual-to-physical address translation is not found in the compressed page table.

13. The method as in claim 12 further comprising:
updating a shared TLB (STLB), data TLB (DTLB) and/or instruction TLB (ITLB) to include an address translation read from page tables stored in system memory in response to the page walk operation.

14. The method as in claim 11 wherein the TLB comprises an instruction TLB (ITLB) to store address translations associated with instructions, a data TLB (DTLB) to store address translations associated with data, and a shared TLB (STLB) to store address translations for both instructions and data, the method further comprising filling the STLB and/or the ITLB/DTLB using an address translation from the compressed page table when a desired virtual-to-physical address translation is not present in the STLB or ITLB/DTLB.

15. The method as in claim 11 wherein entries in the compressed page table comprise:
a first set of fields to be used to determine a match using a linear address (LA); and
a second set of fields including a physical address (PA) corresponding to the LA.

16. The method as in claim 15 wherein the first set of fields includes a virtual processor ID (VPID) field to indicate a virtual processor to which each compressed page table entry is assigned.

17. The method as in claim 16 wherein the first set of fields further includes a range size field to indicate a page size used in the page tables.

18. The method as in claim 15 wherein the second set of fields further includes a set of permission bits indicating permissions associated with the page tables.

19. The method as in claim 18 wherein the permissions include write enable, read enable, and execute enable.

20. The method as in claim 15 wherein the second set of fields further includes a user/supervisor bit to indicate a user or supervisor mode of operation.

21. A system comprising:
an input/output (I/O) interface to receive user input via a mouse, keyboard and/or other cursor control device;
a memory for storing instructions and data;
a cache having a plurality of cache levels for caching the instructions and data;
a host processor for executing the instructions and data responsive to the user input, the host processor comprising:
a translation lookaside buffer (TLB) to store virtual-to-physical address translations;
a page miss handler (PMH) to process TLB misses when a desired virtual-to-physical address translation is not present in the TLB; and
a compressed page table to be managed by the PMH, the compressed page table to store specified portions of page tables, wherein in response to a TLB miss for a first address translation, the PMH is to check the compressed page table to determine if a page table entry corresponding to the first address translation is stored therein and, if so, to provide the first address translation from the compressed page table;
a graphics processing unit (GPU) to execute graphics commands provided from the host processor, the graphics commands to cause the GPU to render graphics images; and
a video output logic to render the graphics images on a display responsive.

22. The system as in claim 21 wherein the PMH includes page walk logic to perform a page walk operation to read entries from page tables stored in a system memory if the first address translation is not found in the compressed page table.

23. The system as in claim 22 wherein the PMH is to update the compressed page table to include an address translation read from page tables stored in system memory in response to the page walk operation.

24. The system as in claim 21 wherein the TLB comprises:
an instruction TLB (ITLB) to store address translations associated with instructions;
a data TLB (DTLB) to store address translations associated with data; and
a shared TLB (STLB) to store address translations for both instructions and data;
wherein the PMH fills the STLB and/or the ITLB/DTLB using an address translation from the compressed page table when a desired virtual-to-physical address translation is not present in the STLB or ITLB/DTLB.
